(19) United States
(12) Patent Application Publication
(10) Pub. No.: US 2026/0316449 A1
(43) Pub. Date: Oct. 15, 2026

(54) LIQUID DISCHARGE HEAD SUBSTRATE AND LIQUID DISCHARGE HEAD USING LIQUID DISCHARGE HEAD SUBSTRATE

(71) Applicant: CANON KABUSHIKI KAISHA, Tokyo (JP)

(72) Inventors: SHINYA IWAHASHI, Kanagawa (JP); TAKERU YASUDA, Kanagawa (JP); YUZURU ISHIDA, Kanagawa (JP); YOHEI OSUKI, Chiba (JP); TOSHIO NEGISHI, Kanagawa (JP)

(21) Appl. No.: 19/632,024

(22) Filed: Mar. 27, 2026

(30) Foreign Application Priority Data
Apr. 10, 2025 (JP) 2025-065056

(51) Int. Cl. B41J 2/14

(52) U.S. Cl. CPC B41J 2/14072; B41J 2/1408; B41J 2/14112

(57) ABSTRACT

A liquid discharge head substrate includes: a base; and on a first surface of the base, an insulating layer including a first electrical wiring layer; a resistive heating element for discharging liquid; and a second electrical wiring layer, wherein the insulating layer includes therein a connecting member connecting the first electrical wiring layer and the resistive heating element in addition to the first electrical wiring layer, and the second electrical wiring layer is provided further upward than the insulating layer with respect to the first surface of the base, has a function as a power source wiring for supplying electric current to the resistive heating element, and is thicker than the first electrical wiring layer.

### BACKGROUND

### Field of the Technology

The disclosure relates to a liquid discharge head substrate and a liquid discharge head using the liquid discharge head substrate.

### Description of the Related Art

A thermal system has been known as one liquid discharging type for liquid discharge heads. The thermal system induces bubbling phenomenon of liquid by thermal energy generated by a resistive heating element and the phenomenon is utilized to discharge the liquid.

For the liquid discharge head that discharges liquid, which is mounted on a liquid discharge apparatus that discharges liquid, it is useful to effectively transmit energy for discharging liquid to the liquid to reduce power consumption. To that end, for example, for a liquid discharge head for what is known as a thermal system using thermal energy, it is useful to reduce the film thickness of an insulating protection layer, which covers a resistive heating element that generates heat to discharge liquid.

Here, Japanese Patent Laid-Open No. 2002-144571 (Patent Literature 1) proposes to reduce the film thickness of an insulating protection layer that covers a resistive heating element by smoothing a stacked member that is stacked on a liquid discharge head substrate.

Patent Literature 1 describes a configuration for smoothing stacked member that is stacked on a liquid discharge head substrate that has been known. Specifically, an interlayer insulating film is deposited on a second electrical wiring layer electrically connected to a resistive heating element. Next, an interlayer insulating film is smoothed by CMP (Chemical Mechanical Polishing) such that steps caused by the second electrical wiring layer are prevented from appearing on a surface of the interlayer insulating film. Then, the second electrical wiring layer and the resistive heating element are connected to each other by a tungsten via. It is proposed to allow the resistive heating element and the second electrical wiring layer to be generally smoothed by using the configuration and thereby thin a protective layer that covers the upper surfaces.

However, in a case where the second electrical wiring layer is miniaturized to reduce the size of the liquid discharge head substrate, the second electrical wiring layer may be thickened to reduce the wiring resistance and the interlayer insulating film may also be thickened for protecting the second electrical wiring layer. The interlayer insulating film is made of silicon oxide film, and the silicon oxide film is a material that has high heat storage capacity. Consequently, such a liquid discharge head substrate that uses a silicon oxide film as the interlayer insulating film and is configured such that the second electrical wiring layer and the resistive heating element are connected to each other by a tungsten via leads to a decrease in heat dissipation efficiency after discharge of liquid.

Therefore, in a configuration in which the resistive heating element is connected to the second electrical wiring layer by a tungsten via, there is a need for a liquid discharge head substrate that makes it possible to suppress a decrease in heat dissipation efficiency even in a case where the second electrical wiring layer is thicken.

In a configuration in which a resistive heating element is connected to a second electrical wiring layer by a tungsten via, there is a need for a liquid discharge head substrate that makes it possible to suppress a decrease in heat dissipation efficiency even in a case where the second electrical wiring layer is thickened.

### SUMMARY

The present disclosure addresses these issues and provides a liquid discharge head substrate that makes it possible to suppress a decrease in heat dissipation efficiency even in a case where the second electrical wiring layer is thickened.

According to some embodiments of the present disclosure, a liquid discharge head substrate includes: a base; and on a first surface of the base, an insulating layer including a first electrical wiring layer; a resistive heating element for discharging liquid; and a second electrical wiring layer, wherein the insulating layer includes therein a connecting member connecting the first electrical wiring layer and the resistive heating element in addition to the first electrical wiring layer, and the second electrical wiring layer is provided further upward than the insulating layer with respect to the first surface of the base, has a function as a power source wiring for supplying electric current to the resistive heating element, and is thicker than the first electrical wiring layer.

Features of the present disclosure will become apparent from the following description of embodiments with reference to the attached drawings. The following description of embodiments is described by way of example.

### BRIEF DESCRIPTION OF THE DRAWINGS

FIG. 1A illustrates a liquid discharge head and is a perspective view around the liquid discharge head.

FIG. 1B illustrates the liquid discharge head and is a broken view around a liquid discharge port of the liquid discharge head of FIG. 1A.

FIG. 2 illustrates an arrangement region in the liquid discharge head substrate according to an embodiment of the disclosure; in FIG. 2, (a) is a plan view of an arrangement before being highly densified, (b) is an enlarged view of a region IIb in (a), (c) is a plan view of a highly-densified arrangement, and (d) is an enlarged view of a region IId in (c).

FIG. 3 illustrates a liquid discharge head substrate according to Example 1; (a) is a plan view of the liquid discharge head substrate, and (b) is a cross-sectional view taken at a IIIb-IIIb line.

FIG. 4 illustrates a liquid discharge head substrate according to a comparative example; (a) is a plan view of the liquid discharge head substrate, and (b) is a cross-sectional view taken at a IVb-IVb line.

FIG. 5 illustrates a liquid discharge head substrate according to Example 2; (a) is a plan view of the liquid discharge head substrate, and (b) is a cross-sectional view taken at a Vb-Vb line in (a).

### DESCRIPTION OF THE EMBODIMENTS

Various exemplary embodiments, features, and aspects will now be described in detail with reference to appended drawings. The embodiments described below are not intended to limit the present disclosure according to the claims. While more than one feature is described in the embodiment, not all the features are necessarily essential to the present disclosure, and the features may be in any combination. Furthermore, in the appended drawings, same reference signs are used for same or similar configurations, and redundant descriptions will not be repeated.

The term "liquid" in the specification includes any liquid that can be used for image forming, printing, or processing of a recording medium and the like by being applied to the recording medium. Accordingly, the term "liquid" in the specification refers to a concept encompassing any liquid that can be used for recording, printing, or processing and includes ink and the like. Furthermore, the concept of recording is not particularly limited and may also be applicable to industrial applications. For example, recording may be used for biochip fabrication, printing for electronic circuits, semiconductor substrate fabrication, and the like.

For the liquid discharge head substrate (element substrate) and the liquid discharge head of the disclosure, the following definitions are made. In the description in the specification, the relationships in the layered structure may be described by using terms such as "above", "upper side", "up", "below", "lower side", and "down" relative to a surface of a member as desired. For these terms, with respect to the "base" of the liquid discharge head substrate of the disclosure, a direction toward the resistive heating element or the liquid discharge port of the liquid discharge head substrate is defined as "up", "upper side or upward", and the like, and an opposite direction (direction toward the base) is defined as "down", "lower side", and the like. Accordingly, terms such as "on the plane", "on the surface", "upper surface", or "lower surface" refer to an upper side or a lower side of the "plane" or the "surface" of interest of a layer or a film. Specifically, for example, "on the base" refers to being on a base surface on the side (upper side) of the liquid discharge head substrate on which the resistive heating element or the liquid discharge port is provided.

### Liquid Discharge Head

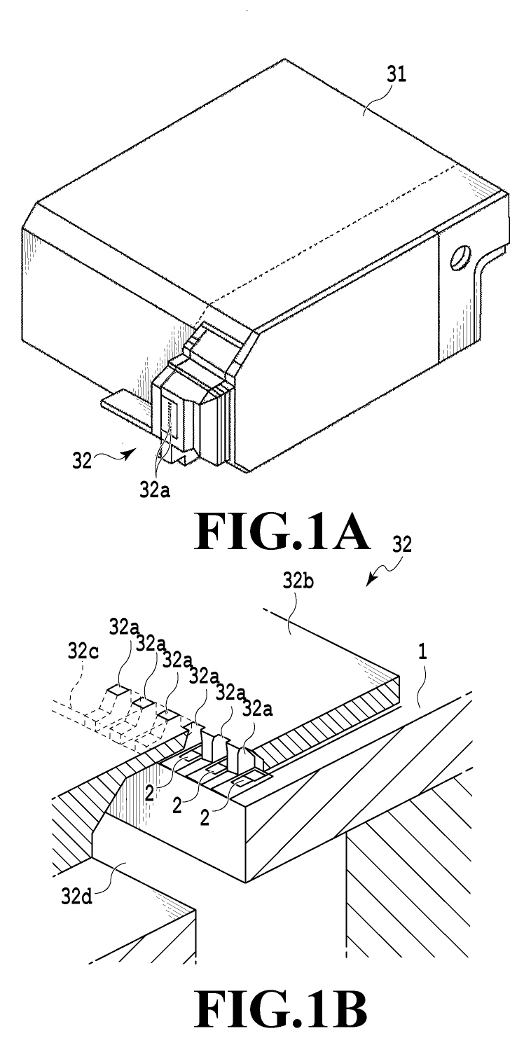

The liquid discharge head of the disclosure will be described with reference to FIGS. 1A and 1B. The liquid discharge head of the embodiment includes a liquid tank 31 that contains liquid (for example, ink) and a liquid discharge head 32.

FIG. 1A is a perspective view of the liquid tank 31 and the liquid discharge head 32 in a single unit. The liquid tank 31 and the liquid discharge head 32 are separable at the position of a broken line in FIG. 1A. The liquid discharge head 32 includes a plurality of liquid discharge port 32a for discharging the liquid.

FIG. 1B is a broken view of the liquid discharge head 32 illustrating the structure around the liquid discharge port 32a. As illustrated in FIG. 1B, the liquid discharge head 32 includes a channel-forming member 32b and a liquid discharge head substrate 1. The channel-forming member 32b is provided on the liquid discharge head substrate 1 and includes liquid discharge ports 32a, and a channel 32c and a common liquid chamber 32d for supplying the liquid to each liquid discharge port 32a. The liquid discharge head substrate 1 is provided with a liquid discharge element 2 corresponding to each liquid discharge port 32a. There is provided a plurality of liquid discharge elements 2. The liquid discharge element 2 of the embodiment is an element that generates energy for discharging the liquid by electric power being supplied, and in particular is a resistive heating element (thermoelectric converter). The resistive heating element (thermoelectric converter) generates a bubble in the liquid if it is heated by receiving electricity and uses the bubbling energy to discharge the liquid from the liquid discharge port 32a. In the description below, the liquid discharge element 2 will be referred to as the resistive heating element.

### Liquid Discharge Head Substrate (Element Substrate)

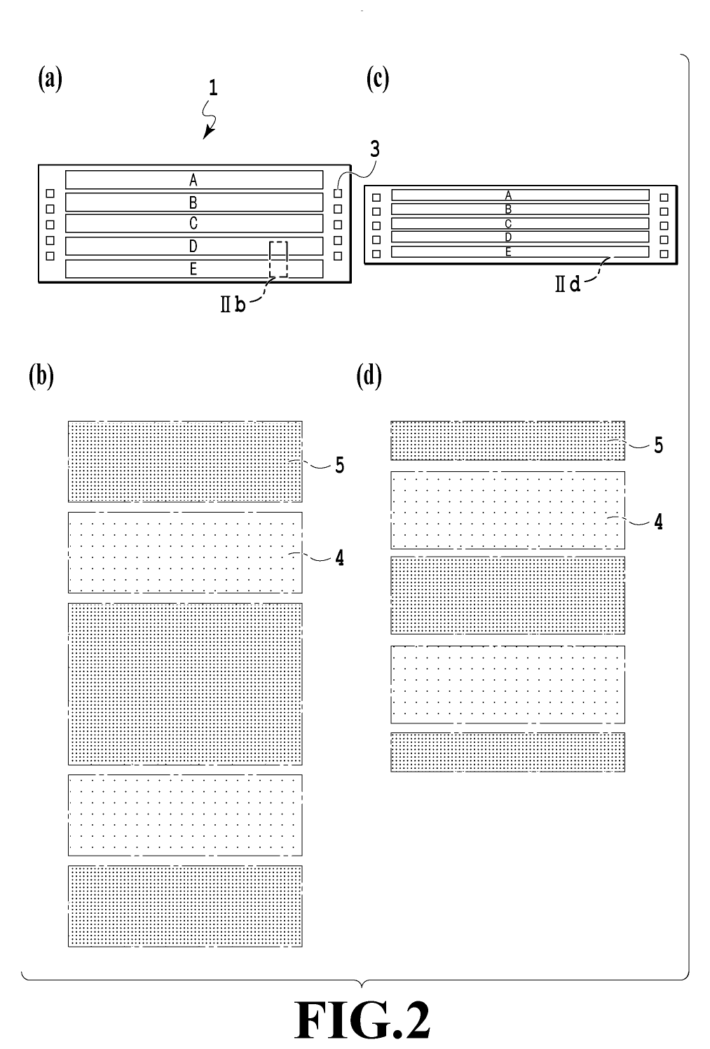

FIG. 2 is a plan view illustrating an arrangement region inside the liquid discharge head substrate 1. FIGS. 2 (a) and (c) each illustrate the arrangement of the liquid discharge head substrate 1, and FIG. 2 (c) is a schematic diagram of a case in which the width of the arrangement region in FIG. 2(a) in the transverse direction is reduced. FIG. 2 (b) and FIG. 2 (d) are enlarged views of the region IIb in FIG. 2 (a) and the region IId in FIG. 2 (c), respectively. The liquid discharge head substrate 1 has a rectangular shape in terms of the shape as viewed in plan view, and a row of a plurality of electrode pad 3 is formed at each end thereof in the longitudinal direction. The electrode pad 3 is an electric contact with the liquid discharge head 32. Five arrays denoted as A to E are provided on the liquid discharge head substrate 1 in the longitudinal direction. In each array, arrangement regions 4 for resistive heating elements 2 corresponding to the row of a plurality of liquid discharge port 32a and arrangement regions 5 for wiring and the common liquid chamber 32d on opposite sides of the arrangement region 4 are formed. In a case where the area of the second electrical wiring layer for supplying electric power to the resistive heating element 2 is a determining factor in the width of the liquid discharge head substrate 1 in the transverse direction, reducing the width of the second electrical wiring layer makes it possible to reduce the size of the liquid discharge head substrate 1. Since reducing the width of the second electrical wiring layer leads to a decrease in resistance of the wiring, the electrical wiring layer may be thickened for compensation thereof.

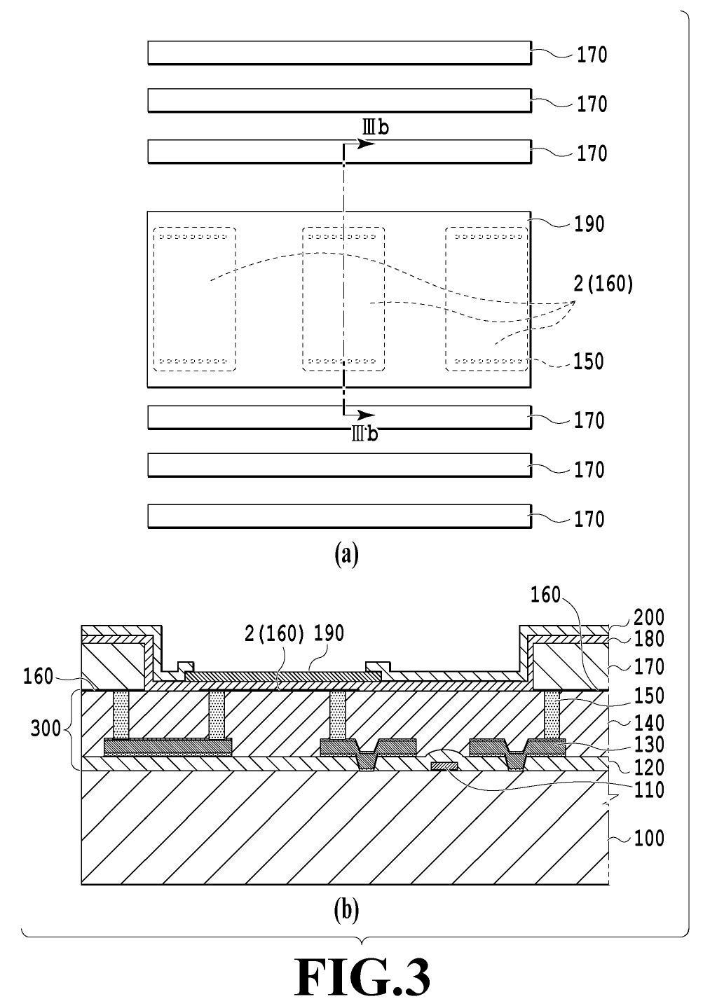

The configuration of the liquid discharge head substrate 1 will further be described with reference to FIG. 3. FIG. 3 illustrates the vicinity of the resistive heating element 2 and the arrangement region of the second electrical wiring layer. FIG. 3 (a) is a plan view of the vicinity of the resistive heating element 2 and the arrangement region of the second electrical wiring layer, parts of which are enlarged, and FIG. 3 (b) is a cross-sectional view taken at a IIIb-IIIb line in FIG. 3 (a).

A base 100 is a plate-like member that contains, for example, silicon (Si) as a main component. A circuit (not illustrated) for selectively driving each resistive heating element 2 is formed on the base 100. The circuit includes a driving element composed of a semiconductor element such as a switching transistor, a gate electrode layer 110 containing polysilicon (PolySi) as a main component, and the like.

A first interlayer insulating layer 120 that contains, for example, silicon oxide (SiO) as a main component is arranged on a surface of the driving element. A first electrical wiring layer 130 is arranged on the upper surface of the first interlayer insulating layer 120. The first electrical wiring layer 130 is in contact with the semiconductor element through a contact hole formed in the first interlayer insulating layer 120. The first electrical wiring layer 130, which is also buried in the contact hole, is made of copper aluminum (AlCu) containing, for example, aluminum as a main component with a thickness of about 0.3 μm or more and about 0.6 μm or less. A first contact metal layer 131 and a first barrier metal layer 132 may be formed on the lower surface of the first electrical wiring layer 130, and a first anti-reflection layer 133 may be formed on the upper surface of the first electrical wiring layer 130. The first contact metal layer 131 is, for example, made of titanium (Ti) with a thickness of about 10 nanometer (nm) or more and about 50 nm or less. The first barrier metal layer 132 is, for example, made of titanium nitride (TiN) with a thickness of about 50 nm or more and about 200 nm or less. The first anti-reflection layer 133 is, for example, made of titanium nitride (TiN) with a thickness of about 10 nm or more and about 50 nm or less. A second interlayer insulating layer 140 (also simply referred to as an insulating layer in the disclosure) that contains, for example, SiO as a main component is formed such that the first electrical wiring layer 130 is covered. The first electrical wiring layer 130 has projections and gaps due to patterns of wiring. Conforming to the projections and gaps, the projections and gaps of the second interlayer insulating layer 140 are formed on the second interlayer insulating layer (insulating layer) 140. The projections and gaps of the second interlayer insulating layer 140 can be smoothed by, for example, CMP (Chemical Mechanical Polishing).

A resistive layer 160 is formed on the smoothed upper surface of the second interlayer insulating layer (insulating layer) 140. The resistive layer 160 has a thickness of about 10 nm or more and about 50 nm or less, and may be made of, for example, tantalum silicon nitride (TaSiN) as a main component.

The first electrical wiring layer 130 and the resistive layer 160 are each electrically connected by a plurality of vias 150. The via 150 is formed in a hole (through hole) passing through from the upper surface of second interlayer insulating layer (insulating layer) 140 to the first electrical wiring layer. Although not shown in FIG. 3, the via 150 includes a second contact metal layer 151 in contact with the first electrical wiring layer 130, a second barrier metal layer 152, and a hole buried layer 153 which is a main constituent. The second contact metal layer 151 is made of, for example, titanium (Ti) with a thickness of about 10 nm or more and about 50 nm or less, and the second barrier metal layer 152 is made of, for example, titanium nitride (TiN) with a thickness of about 50 nm or more and about 100 nm or less. Furthermore, the hole buried layer 153 is formed, for example, by burying a material such as tungsten (W) in the hole with a film thickness corresponding to the hole diameter.

A second electrical wiring layer 170 is formed on the upper surface of the second interlayer insulating layer (insulating layer) 140. The second electrical wiring layer 170 is, for example, made of AlCu containing aluminum as a main component. Furthermore, the second electrical wiring layer 170 is used as an electric power wiring (i.e., has a function as a power source wiring) and may be of low resistance. Accordingly, the second electrical wiring layer 170 can have a film thickness of, for example, about 0.6 micrometer (μm) or more and about 1.5 μm or less. In this way, the second electrical wiring layer 170 is formed thicker than the first electrical wiring layer 130.

The resistive layer 160 may or may not be interposed between the second interlayer insulating layer (insulating layer) 140 and the second electrical wiring layer 170 in a stacked direction (direction from the base 100 toward the second electrical wiring layer 170). In a case where the resistive layer 160 is interposed, a location in which the second electrical wiring layer 170 is in contact onto the resistive layer 160 is not subjected to heat generation. Accordingly, the location in which the resistive layer 160 and the second electrical wiring layer 170 are in contact with each other does not function as a resistive heating element. Consequently, a portion of the resistive layer 160 in which the second electrical wiring layer 170 is not in contact with the upper surface of the resistive layer 160 works as the resistive heating element 2.

Note that as illustrated in FIG. 3 (b), electrical connection is made from the first electrical wiring layer 130 to the second electrical wiring layer 170 by the via 150 as in the case between the first electrical wiring layer 130 and the resistive layer 160.

An insulating protection layer 180 is used for insulation protection of the resistive heating element 2 and the second electrical wiring layer 170. The insulating protection layer 180 is made of, for example, silicon nitride (SiN) as a main component with a thickness of about 100 nm or more and about 300 nm or less.

As illustrated in FIG. 3, an anti-cavitation layer 190 is formed on the upper surface of the insulating protection layer 180 covering the resistive heating element 2 in plan view. The anti-cavitation layer 190 is, for example, composed of a single-layer film or a stacked film that contains tantalum (Ta), iridium (Ir), and the like as a main component with a thickness of about 100 nm or more and about 300 nm or less.

An anti-liquid insulating protection layer 200 is formed covering the insulating protection layer 180 and the anti-cavitation layer 190. The anti-liquid insulating protection layer 200 is made of, for example, silicon carbonitride (SiCN) as a main component with a thickness of about 150 nm or more and about 400 nm or less.

From the viewpoint of energy efficiency for discharging liquid, it is desirable that an insulating material on the upper side (on the side of the liquid discharge port) of the resistive heating element 2 is not too thick. To that end, in the embodiment, the anti-liquid insulating protection layer 200 is not arranged at least on a heat generation region of the resistive heating element 2 in plan view. On the other hand, thickening of an insulating material on the upper side of the second electrical wiring layer 170 will not affect the energy efficiency for discharging liquid. Accordingly, any region other than the heat generation region of the resistive heating element 2 can be covered with the anti-liquid insulating protection layer 200 to further improve protective characteristics. Note that the anti-liquid insulating protection layer 200 is not limited to an inorganic film such as SiCN and may be an organic film such as epoxy resin. Alternatively, an inorganic film and an organic film may be stacked.

Hereinafter, in the disclosure, a layer made solely of a metal material such as Al, Cu, Ta, and Ir, or made of alloy thereof will also be represented as a metallic layer, and any layer other than a metallic layer will also be represented as a non-metallic layer.

In the embodiment, in a configuration in which the resistive heating element that is excellent in energy efficiency for discharging liquid is connected to the second electrical wiring layer by a tungsten via, it is possible to achieve both thickening of the second electrical wiring layer 170 and heat dissipation efficiency. For more improved heat dissipation efficiency, a configuration may be adopted in which a material that has a thermal conductivity higher than silicon oxide film is inserted as a heat dissipation plate as a layer below the resistive heating element 2 (heat dissipation plate is not illustrated). For example, the heat dissipation plate may be formed as the same layer as the first electrical wiring layer 130 or may be formed as the same layer as the gate electrode layer 110. In this way, it is possible to effectively thin a silicon oxide film, which has high heat storage capacity, and thereby further improve the heat dissipation efficiency.

In the disclosure above, layers in the liquid discharge head substrate have been described, whereas the layers can be formed appropriately by using a process known in the art (for example, CVD (Chemical Vapor Deposition) method, sputtering method, and the like).

As described above, the liquid discharge head substrate of the disclosure configured such that the resistive heating element is connected to second electrode wiring layer by a tungsten via has been described. As described above, the liquid discharge head substrate of the disclosure makes it possible to suppress the thickness of a heat storage layer 300 from the surface on which the resistive layer 160 is formed to the base 100. Then, while the thickness of the heat storage layer 300 is suppressed, the second electrical wiring layer can be thickened. Furthermore, even in a case where the second electrical wiring layer is thickened in this way, it is possible to provide a liquid discharge head substrate with a decrease in heat dissipation efficiency being suppressed.

### Examples

In the following, specific examples of layer configurations further upward than the second interlayer insulating layer (insulating layer) 140 of the liquid discharge head substrate 1 will be described with reference to drawings. In Examples below, terms representing upper layers (on an upper side of a layer) such as being above the layer refers to layers located further upward than the second interlayer insulating layer 140 relative to the base 100. Furthermore, layers located between the second interlayer insulating layer (insulating layer) 140 and the base 100 were formed within the range of conditions of above-described film thicknesses and the like.

Example 1

The second interlayer insulating layer 140 was smoothed by CMP such that the film thickness of the heat storage layer 300 which includes the layers from the surface for forming the resistive layer 160 in FIG. 3 (b) to the base 100 (silicon substrate) became 3 μm, and the via 150 was finally formed. The base 100 to the surface on which the resistive layer 160 was formed were formed by using the methods below.

Gate electrode layer 110 : CVD method

First interlayer insulating layer 120 : CVD method

First contact metal layer 131 : sputtering method

First barrier metal layer 132 : sputtering method

First electrical wiring layer 130 : sputtering method

First anti-reflection layer 133 : sputtering method

Second interlayer insulating layer (insulating layer) 140 : CVD method

Second contact metal layer 151 : sputtering method

Second barrier metal layer 152 : sputtering method

Hole buried layer 153 : CVD method

The resistive layer 160 made of TaSiN (non-metallic layer) was formed on the surface for forming the resistive layer 160 with the thickness of 15 nm by a sputtering method. The second electrical wiring layer 170 made of AlCu (metallic layer) functioning as a power source wiring was formed on the resistive layer 160 as a power source wiring formation portion with the thickness of 1 μm by a sputtering method. The insulating protection layer 180 made of SiN (non-metallic layer) was formed such that the resistive layer 160 and the second electrical wiring layer 170 were covered, with the thickness of 250 nm by a CVD method. The anti-cavitation layer 190 made of stacked Ta/Ir/Ta (stacked metallic layer) was formed such that the insulating protection layer 180 was covered, with the thickness of 250 nm by a sputtering method. As illustrated in FIG. 3 (a), any anti-cavitation layer 190 is not formed in a region in which it overlaps the second electrical wiring layer 170 in plan view. This configuration makes it possible to prevent any current path from being created between the second electrical wiring layer 170 and the anti-cavitation layer 190 due to insufficient insulation of the insulating protection layer 180. On the layers, the anti-liquid insulating protection layer 200 made of SiCN (non-metallic layer) was formed with the thickness of 300 nm by a CVD method. From the viewpoint of energy efficiency for discharging liquid, any anti-liquid insulating protection layer 200 is not arranged at least on a heat generation region of the resistive heating element 2 in plan view. The reason for no need for the arrangement of anti-liquid insulating protection layer 200 is that liquid resistance is ensured by the anti-cavitation layer 190, and that the resistive layer 160 is thin and sufficient insulation is ensured solely by the insulating protection layer 180, which is different from the case of being on the second electrical wiring layer 170. On the other hand, since the second electrical wiring layer 170 is thin, it may be possible that a decrease in film thickness and the degradation of film quality of the insulating protection layer 180 occur along a side wall portion of the second electrical wiring layer 170. Accordingly, the anti-liquid insulating protection layer 200 is arranged in a region in which any resistive heating element 2 is not formed. In this way, it is possible to provide a liquid discharge head substrate that can achieve both energy efficiency for discharging liquid and heat dissipation efficiency.

As described above, the liquid discharge head substrate of the Examples has the following features. That is, the liquid discharge head substrate of the present disclosure includes the insulating layer (the second interlayer insulating layer 140), the resistive heating element 2 for discharging liquid, and the second electrical wiring layer 170 with respect to the upper surface of the base 100 (i.e., on the first surface). The first electrical wiring layer and the connecting member (for example, via 150) that connects the first electrical wiring layer and the resistive heating element to each other are included in the insulating layer (in the second interlayer insulating layer 140). The second electrical wiring layer is provided further upward than the insulating layer (the second interlayer insulating layer 140) with respect to the upper surface (first surface) of the base 100, has a function as a power source wiring for supplying electric current to the resistive heating element 2, and is thicker than the first electrical wiring layer.

Furthermore, as described above, in Example 1, a non-metallic layer (for example, the insulating protection layer 180) is formed on the resistive heating element 2 with respect to the base 100 (with respect to the first surface of the base). Then, non-metallic layers (for example, the insulating protection layer 180 and the anti-liquid insulating protection layer 200) are arranged on the second electrical wiring layer, such that the total number of non-metallic layers on the second electrical wiring layer is larger than the total number of non-metallic layers on the resistive heating element.

As described above, in the liquid discharge head substrate of the disclosure, non-metallic layers are arranged on the resistive heating element 2 and on the second electrical wiring layer 170 with respect to the base 100 (with respect to the first surface of the base), and only a non-metallic layer is arranged further upward than the second electrical wiring layer.

### Comparative Example

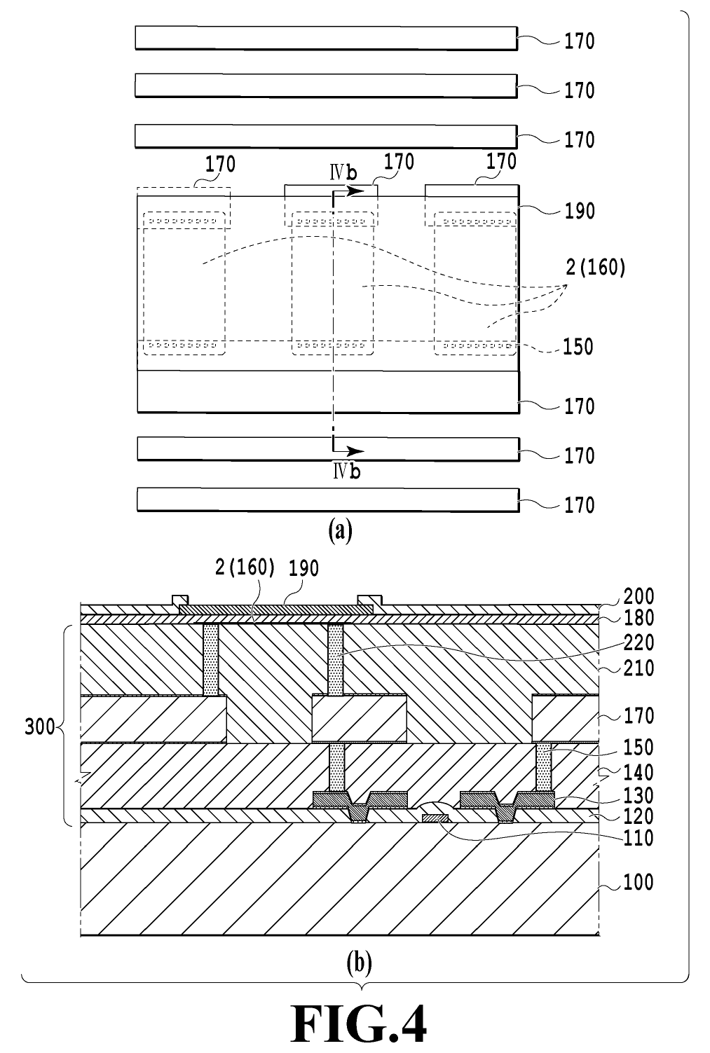

As a comparative example, a configuration is illustrated in which the second electrical wiring layer 170 is arranged as a layer below the resistive layer 160 with reference to FIG. 4, which shows a plan view and a cross-sectional view taken at the same locations. As in Example 1, the second electrical wiring layer 170 made of AlCu was formed with the thickness of 1 μm. A third interlayer insulating layer 210 was formed thereon by performing film forming and CMP. After projections and gaps on the third interlayer insulating layer 210 caused by steps on the second electrical wiring layer 170 were allowed to be sufficiently smoothed by CMP, the total thickness of the second electrical wiring layer 170 and a second via 220 was 3 μm. As a result, the thickness of the heat storage layer 300 from the resistive layer 160 to the base 100 was 6 μm, which was 3 μm thicker than Example 1. The resistive layer 160, the insulating protection layer 180, the anti-cavitation layer 190, and the anti-liquid insulating protection layer 200 thereon were formed with the same film thicknesses as those in Example 1. The thickened heat storage layer led to an increase in heat storage capacity, and therefore, heat dissipation performance degraded and a decrease in throughput tended to occur due to temperature increase of the liquid discharge head substrate 1 during the use of the liquid discharge head.

Example 2

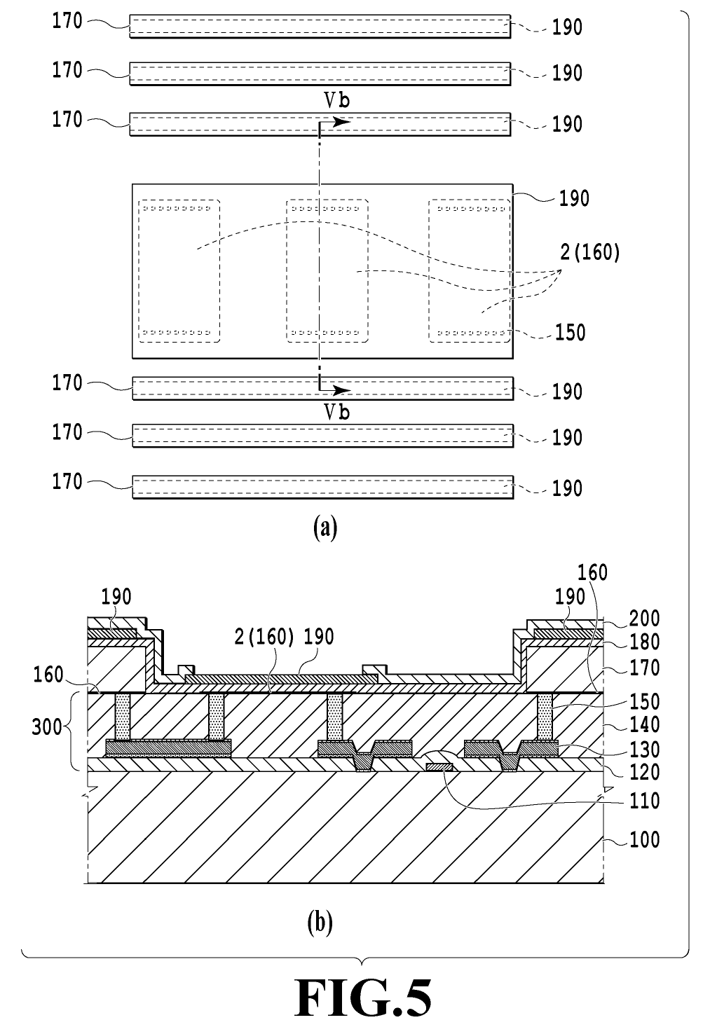

Example 2 is different from Example 1 in that, as illustrated in FIGS. 5 (a) and 5 (b), the anti-cavitation layer 190 is formed in a region in which it overlaps the second electrical wiring layer 170 in plan view. The insulating protection layer 180 arranged on the second electrical wiring layer 170 tends to experience a reduction in protective performance due to a reduction in film thickness and the degradation of film quality, in particular in a stepped side wall portion. In a case where the anti-cavitation layer 190 is to be arranged in a region in which it overlaps the second electrical wiring layer 170, a protection between the second electrical wiring layer 170 and the anti-cavitation layer 190 may be provided by the insulating protection layer 180. If the anti-cavitation layer 190 is arranged throughout the surface and protective performance by the insulating protection layer 180 is insufficient, current leakage may occur to any other second electrical wiring layer 170 through the anti-cavitation layer 190. In order to avoid this, in the present example, patterns of the anti-cavitation layer 190 are separated for each group of the resistive heating elements 2 and each second electrical wiring layer 170, instead of forming an anti-cavitation layer also in a region in which it overlaps the second electrical wiring layer 170.

In this way, even in a case where the anti-cavitation layer 190 is also formed on the second electrical wiring layer 170, it is possible to provide a liquid discharge head substrate in which electric reliability is less likely to be impaired between the second electrical wiring layers 170.

As described above, in the liquid discharge head substrate of the present disclosure, a non-metallic layer is arranged on the resistive heating element 2, and a non-metallic layer and a metallic layer (for example, the anti-cavitation layer 190) are arranged on the second electrical wiring layer 170, with respect to the base 100 (with respect to the first surface of the base). The metallic layer is allocated on a per-second electrical wiring layer basis.

Example 3

In addition to the configuration of the liquid discharge head substrate of Example 2, Example 3 is an example of making an electrical connection such that the same voltage as the voltage applied to each second electrical wiring layer 170 can be applied to the anti-cavitation layer 190 that overlaps the second electrical wiring layer 170 in plan view. In this way, potential difference is less likely to be generated (the same potential) between the second electrical wiring layer 170 and the anti-cavitation layer 190 in a region in which it overlaps the second electrical wiring layer 170 in plan view, and therefore current leakage is prevented. Accordingly, it is possible to provide a liquid discharge head substrate that has electric reliability still higher than Example 2.

In one embodiment, as described above, in the liquid discharge head substrate of the disclosure, a metallic layer (for example, the anti-cavitation layer 190) arranged on the second electrical wiring layer 170 with respect to the base 100 (with respect to the first surface of the base) is at the same potential as the second electrical wiring layer 170.

The disclosure encompasses a liquid discharge head that includes the liquid discharge head substrate 1 described above and a channel-forming member (for example, the channel-forming member 32b).

The liquid discharge head substrate and the liquid discharge head of the disclosure are not limited to the embodiments and Examples and subject to various modifications and variations without departing from the spirit and scope of the disclosure. Accordingly, the appended claims define the scope of the present disclosure.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

### Advantageous Effects of Present Disclosure

According to the disclosure, it is possible to provide a liquid discharge head substrate that is excellent in energy efficiency for discharging liquid and heat dissipation efficiency.

This application claims the benefit of priority from Japanese Patent Application No. 2025-065056, filed April 10, 2025, which is hereby incorporated by reference herein in its entirety.

What is claimed is:

1. A liquid discharge head substrate, comprising:
a base; and
on a first surface of the base,
an insulating layer including a first electrical wiring layer;
a resistive heating element for discharging liquid; and
a second electrical wiring layer, wherein
the insulating layer includes therein a connecting member connecting the first electrical wiring layer and the resistive heating element in addition to the first electrical wiring layer, and
the second electrical wiring layer is provided further upward than the insulating layer with respect to the first surface of the base, has a function as a power source wiring for supplying electric current to the resistive heating element, and is thicker than the first electrical wiring layer.

2. The liquid discharge head substrate according to claim 1, wherein at least one non-metallic layer is arranged on the resistive heating element and on the second electrical wiring layer with respect to the first surface of the base, and a total number of non-metallic layers on the second electrical wiring layer is larger than a total number of non-metallic layers on the resistive heating element.

3. The liquid discharge head substrate according to claim 1, wherein at least one non-metallic layer is arranged on the resistive heating element and on the second electrical wiring layer with respect to the first surface of the base, and only the at least one non-metallic layer is arranged further upward than the second electrical wiring layer.

4. The liquid discharge head substrate according to claim 1, wherein a non-metallic layer is arranged on the resistive heating element and a non-metallic layer and a metallic layer are arranged on the second electrical wiring layer with respect to the first surface of the base, and the metallic layer is allocated on a per-second electrical wiring layer basis.

5. The liquid discharge head substrate according to claim 4, wherein a metallic layer arranged on the second electrical wiring layer with respect to the first surface of the base is at the same potential as the second electrical wiring layer.

6. A liquid discharge head, comprising:
a liquid discharge head substrate; and
a channel-forming member including a discharge port through which liquid is discharged, the liquid discharge head substrate including:
a base; and
on a first surface of the base,
an insulating layer including a first electrical wiring layer;
a resistive heating element for discharging liquid; and
a second electrical wiring layer, wherein
the insulating layer includes therein a connecting member connecting the first electrical wiring layer and the resistive heating element in addition to the first electrical wiring layer, and
the second electrical wiring layer is provided further upward than the insulating layer with respect to the first surface of the base, has a function as a power source wiring for supplying electric current to the resistive heating element, and is thicker than the first electrical wiring layer.
